(19) United States
(12) Patent Application Publication
(10) Pub. No.: US 2013/0047710 A1
(43) Pub. Date: Feb. 28, 2013

(54) NONLINEAR, BIFURCATION-BASED MASS SENSOR

(71) Applicants: Jeffrey Frederick Rhoads, West Lafayette, IN (US); Vjay Kumar, Chennnai (IN)

(72) Inventors: Jeffrey Frederick Rhoads, West Lafayette, IN (US); Vjay Kumar, Chennnai (IN)

(73) Assignee: Purdue Research Foundation, West Lafayette, IN (US)

(21) Appl. No.: 13/595,929

(22) Filed: Aug. 27, 2012

Related U.S. Application Data
(60) Provisional application No. 61/528,057, filed on Aug. 26, 2011.

(51) Int. Cl. G01N 29/02

(52) U.S. Cl. 73/64.53

(57) ABSTRACT

Nonlinear sensors, which actively exploit dynamic transitions across sub-critical or saddlenode bifurcations in the device's frequency response, can exhibit improved performance metrics and operate effectively at smaller scales. This sensing approach directly exploits chemomechanically induced amplitude shifts for detection. Accordingly, it has the potential to eliminate the need for numerous power-consuming signal processing components in final sensor implementations. Various embodiments pertain to low-cost, linear and nonlinear bifurcation-based mass sensors founded upon selectively functionalized, piezoelectrically actuated microcantilevers. Yet other embodiments pertain to an amplitude-based sensing approach based upon dynamic transitions across saddle-node bifurcations that exist in a sensor's nonlinear frequency response.

### CROSS REFERENCE TO RELATED APPLICATION

This application claims the benefit of priority to U.S. Provisional Patent Application Ser. No. 61/528,057, filed Aug. 26, 2011, incorporated herein by reference.

### FIELD OF THE INVENTION

Various embodiments of the present invention relate to measuring and testing, and more specifically to detection of materials in fluids.

### BACKGROUND OF THE INVENTION

The potential to detect very small amounts of added mass has driven research in chemical and biological sensors based on resonant micro- and nano-electromechanical systems over the past two decades. Since the initial demonstrations of microscale resonant mass sensing in water vapor and mercury detection, the field has expanded to encompass a wide variety of applications ranging from medical diagnostics and environmental safety to national security and public safety. Resonant mass sensors typically utilize chemomechanically-induced shifts in the frequency response of an isolated resonator or an array of resonators for analyte detection. While traditional sensors have utilized shifts in the linear natural frequency, recent work has demonstrated that sensors that exploit alternative techniques, such as tracking the shift in the resonance frequency under parametric excitation or utilizing the sensor's nonlinear resonant frequency, could potentially improve the performance metrics of the device.

While mass sensors based on chemomechanical shifts in linear resonant frequency has provided distinct utility in terms of sensitivity and application space, sensors that exploit the amplitude shifts that are characteristic to the nonlinear frequency response of a system have the potential to further simplify final device implementations by eliminating the need to employ the frequency tracking hardware that is typically required to implement a conventional microscale mass sensor.

This work demonstrates an amplitude-based mass sensing approach, which utilizes dynamic transitions that occur near a saddle-node bifurcation in the frequency response of a directly-excited microscale resonator.

### SUMMARY OF THE INVENTION

Various embodiments of the present invention pertain to the development of linear and nonlinear, bifurcation-based mass sensors based on piezoelectrically actuated microresonators. A detailed nonlinear model for a representative microcantilever has been developed and analyzed to provide a high-level understanding of pertinent system dynamics. Nonlinear behaviors deemed suitable for bifurcation-based sensing were experimentally verified using Veeco DMASP probes in conjunction with laser vibrometry. Select probes were functionalized using micro-inkjet techniques and initial experimental trials were completed to validate the integrity of the experimental approach.

Some embodiments of the present invention pertain to a method for detecting a compound that includes providing a resonating spring and mass system, the system further including a material structurally integrated with the beam that responds to the presence of the compound by way of a nonlinearity in the dynamic response of the system. Some embodiments include electrically exciting the system to vibrate and measuring the dynamic response of the system both before and after exposure to the compound.

One aspect of the present invention pertains to a system for detecting the presence or concentration of an analyte. Some embodiments include a resonator adapted to adsorb or absorb an analyte. Other embodiments further include an electrical driving circuit configured to piezoelectrically actuate the resonator at a controlled excitation frequency, wherein the resonator exhibits a measurable amplitude response that is a function of the amount of analyte adsorbed or absorbed by the resonator, and there is at least one nonlinearity in the function.

Another aspect of the present invention pertains to a method of detecting the presence or concentration of an analyte. Some embodiments further include piezoelectrically exciting a resonator by applying to it an excitation frequency. Other embodiments further include exposing the resonator to an analyte, wherein the resonator adsorbs or absorbs some of the analyte and has a natural frequency that is a nonlinear function of the stiffness of the resonator and the excitation frequency.

It will be appreciated that the various apparatus and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

FIG. 1(a) is a graph illustrating a shift in frequency response.

FIG. 1(b) is a graph illustrating a saddle-node bifurcation in frequency response.

FIG. 1(c) Frequency response of a typical Duffing-like resonator with a softening nonlinearity. The stable solutions are represented by solid lines while the unstable solutions are represented by dashed lines. Points A and B, where the stable and unstable solutions meet, are saddle-node bifurcation points. As the system transitions from point A′ to A, there is a sudden jump in the response amplitude (the inset shows the time response as the system moves across the bifurcation point, ignoring transient dynamics). This transition, induced by chemomechanical shifts in the natural frequency of the resonator can be correlated to a mass detection event.

FIG. 2(a) is a schematic diagram of a piezoelectrically actuated microbeam according to one embodiment.

FIG. 2(b) is a photograph of a microbeam as in FIG. 2(a).

FIG. 2(c). is a schematic diagram of a typical beam element, with the associated variables used for modeling.

FIG. 3(a) is a graph of the frequency response structure associated with the embodiment of FIG. 2.

FIG. 3(b). Frequency response of a representative microresonator for various values of the effective nonlinear coefficient (N_{eff}) excited with an applied voltage of f=10 V. Stable solutions are represented using solid lines, while the unstable solutions are represented with dashed lines. For negative values of the effective nonlinear coefficient, the system shows softening behavior while for positive values of the effective nonlinear coefficient, the system shows hardening behavior.

FIG. 3(c). The saddle-node bifurcation frequencies (critical value of the detuning parameter σ_{cr}) plotted as a function of excitation voltage for a representative value of the effective nonlinear coefficient (N_{eff}=−0.01). As the excitation voltage increases, the hysteresis between the forward and the reverse sweep also increases.

FIG. 4(a)-FIG. 4(d) illustrate recovered amplitude, frequency, and phase responses from the system of claim 2.

FIG. 5(a) is the inkjet system used for functionalizing the cantilevers illustrated in FIG. 2.

FIG. 5(b) is a photograph of a microbeam as in FIG. 2(a) according to one embodiment of the present invention.

FIGS. 6(a) and 6(b) illustrate, schematically and photographically, respectively, a test apparatus for evaluating sensors according to the illustrated embodiment.

FIG. 7 is a graph of the natural frequency response by a functionalized linear resonant mass sensor as correlated with input of the analyte to the system.

FIG. 8 illustrates a saddle-node bifurcation in amplitude of cantilever-bases sensors according to some embodiments.

FIG. 9 is an SEM image of a Veeco DMASP probe after functionalization.

FIG. 10 is the experimental setup used in evaluating certain embodiments in the current disclosure.

FIG. 11 is a graph of the response of the device illustrated in FIG. 9.

FIG. 12 is a graph of a representative saddle-node bifurcation frequency as a function of time, plotted with the flowrate of the target analyte into the test system of FIG. 10.

FIG. 13 is a graph of the response amplitude verses time for a sensor according to the embodiment tested in the experimental setup of FIG. 10.

FIG. 14 is a pair of graphs illustrating flow rate of methanol (the experimental analyte) and output voltage of the sensor versus time in a two-day experiment using the experimental setup of FIG. 10.

### DESCRIPTION OF THE PREFERRED EMBODIMENT

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates. At least one embodiment of the present invention will be described and shown, and this application may show and/or describe other embodiments of the present invention. It is understood that any reference to “the invention” is a reference to an embodiment of a family of inventions, with no single embodiment including an apparatus, process, or composition that should be included in all embodiments, unless otherwise stated. Further, although there may be discussion with regards to “advantages” provided by some embodiments of the present invention, it is understood that yet other embodiments may not include those same advantages, or may include yet different advantages. Any advantages described herein are not to be construed as limiting to any of the claims.

Although various specific quantities (spatial dimensions, temperatures, pressures, times, force, resistance, current, voltage, concentrations, wavelengths, frequencies, heat transfer coefficients, dimensionless parameters, etc.) may be stated herein, such specific quantities are presented as examples only, and further, unless otherwise noted, are approximate values, and should be considered as if the word “about” prefaced each quantity. Further, with discussion pertaining to a specific composition of matter, that description is by example only, and does not limit the applicability of other species of that composition, nor does it limit the applicability of other compositions unrelated to the cited composition.

What will be shown and described herein, along with various embodiments of the present invention, is discussion of one or more tests that were performed. It is understood that such examples are by way of examples only, and are not to be construed as being limitations on any embodiment of the present invention.

Generally, one form of the present invention is a sensor based on piezoelectrically actuated microcantilevers that exhibits a nonlinear, bifurcation-based response in amplitude as a function of particular input. In one example, the microcantilever adsorbs molecules of gas from the surrounding air, causing its frequency response to exhibit these characteristics.

Chemical and biological sensors based on resonant micro- and nanocantilevers offer distinct utility due to their small size, low power consumption, high sensitivity, and, when bulk fabricated, comparatively low cost. Collectively, these benefits have spurred the implementation of resonant micro- and nanosensors in medical diagnostic, environmental safety, and national security settings. Though a number of transduction mechanisms have been utilized for small-scale mass sensing, piezoelectrically actuated microcantilevers have garnered significant interest of late, due to their self-sensing capability and maturity in the related technical areas of force sensing and scanning probe microscopy.

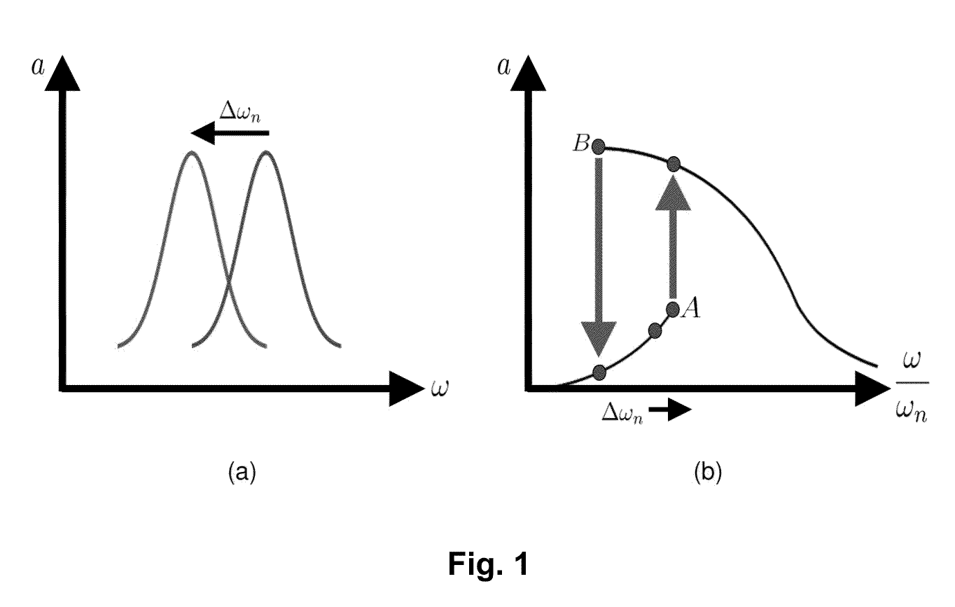

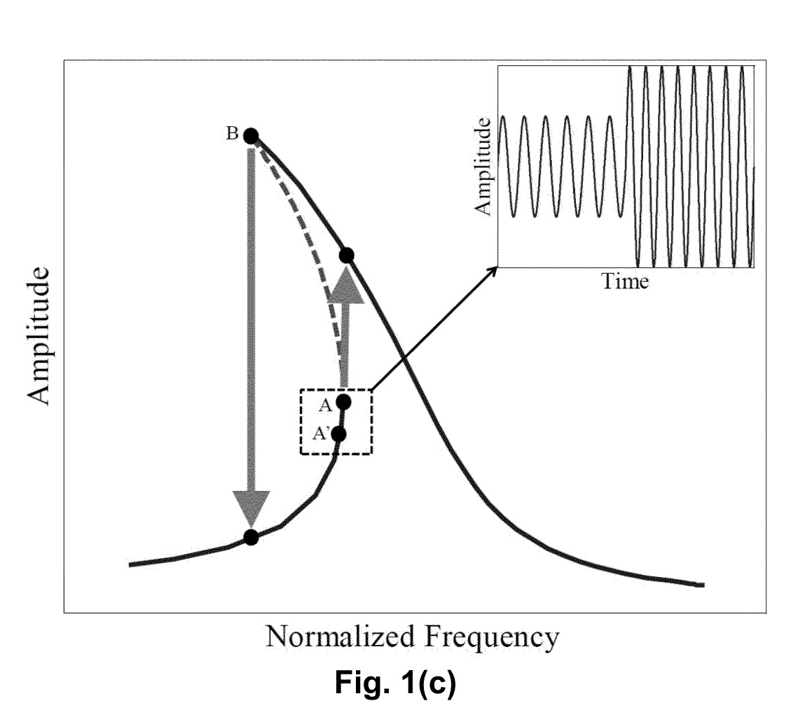

Traditionally, resonant mass sensors have exploited shifts in a linear resonator's natural frequency for analyte detection, such a shift being illustrated in FIG. 1(a). In these devices, the adsorption/absorption of a target analyte onto a selectively functionalized surface layer results in a measurable change in the system's mass or stiffness. This, in turn, leads to a measurable change in the resonator's natural frequency, which can be directly correlated to an analyte detection event, and, in certain cases, used to approximate the analyte's relative concentration in the test environment. Various embodiments of the present invention have demonstrated that improved sensor metrics may be achievable through the active exploitation of nonlinear system behaviors. These nonlinear approaches have particular appeal as they are not only functional at the microscale, but potentially facilitate resonant sensing in nanowire and nanotube-based systems, which can suffer from a limited linear dynamic range.

The target market for various embodiments of the invention is potentially broad. Chemical, biological, and mass sensors based on resonant microsystems are currently being explored for (and, in some cases, implemented in) security, medical, research, and industrial applications. Various inventions described herein are simpler to implement than existing systems, and offer the potential for improved performance characteristics.

The invention is proposed for microscale development. As such, it can be constructed through any of a larger number of microfabrication processes (e.g., standard silicon on insulator processing, SCREAM processing, etc.). Additional details relating to such processes will occur to those skilled in the art.

The invention is realizable in a variety of embodiments. Some of the alternative designs, implementations, and construction methods include operation at a variety of scales, including the millimeter scale, micro-scale, nano-scale, and so on as fabrication methods allow and can be adapted according to the teachings herein. The microcantilevers may be made from single-crystal silicon, polysilicon, diamond, or anything else that can be fabricated at the desired scales and has the desired chemical and/or electrical properties. These devices may be actuated using electrostatic, piezoelectric, thermal, electromagnetic, or other methods as will occur to those skilled in the art. Similarly, the sensing operation of these devices may be electrostatic, piezoelectric, thermal, electromagnetic, or otherwise as will occur to those skilled in the art. Various embodiments of the present invention are not tied to any particular manner of fabrication.

The shapes of the resonators may be changed to have cross-sections (in the plane of the faces having the greatest area) of different shapes, or even different shapes in three dimensions. For example, the resonator may have a microcantilever, generally parallelepiped shape of various cross-sections, or may be a relatively large mass at some distance from its point of attachment. One criterion for selecting a resonator shape for this system is its resonance with a discontinuous, perhaps hysteretic, amplitude.

Microscale resonators that operate in a nonlinear regime have a response that is characterized by the presence of multiple co-existing steady-state solutions (stable and unstable), saddle-node, and/or other bifurcations and hysteretic behavior. FIG. 1(c) shows the steady state amplitude response of a typical microscale resonator with a softening nonlinearity, plotted as a function of the normalized excitation frequency (frequency of excitation normalized by the linear natural frequency of the resonator). The frequencies at which the stable and the unstable solutions meet (points A and B in the figure) are the saddle-node bifurcation frequencies. When the system is operating near these bifurcation frequencies, a small change in the normalized excitation frequency caused by either sweeping the excitation frequency or by a change in the natural frequency of the resonator (caused by the adsorption of mass onto the resonator's surface) results in a sudden change in the response amplitude of the resonator (The inset shows the time response of the system (ignoring the transient dynamics). As the system moves from point A′ to A, the amplitude jumps from the lower solution branch to the upper solution branch). Thus, similar to a shift in the linear natural frequency of the resonator, this abrupt change in the response amplitude is exploited for mass sensing purposes in some embodiments.

Various embodiments of the present invention pertain to development of linear and nonlinear mass and stiffness sensors based on piezoelectrically actuated microresonators. The latter sensors, described at length herein, can include a bifurcation-based sensing approach, which may further include amplitude shifts resulting from chemomechanically induced dynamic transitions across saddle-node bifurcations to signal analyte detection. One nonlimiting example is graphically illustrated in FIG. 1(b).

Although various embodiments shown and described herein refer to softening nonlinearities, the present invention is not so constrained and also contemplates sensors that utilize a hardening response to the presence of the compound. Although in those embodiments including a softening of sensor response a jump from a small response amplitude to large response amplitude signals detection, the opposite can be true in a hardening system.

Further, various embodiments shown and described herein refer to a sensor including a cantilever beam. However, it is recognized that the principles described herein are applicable to any spring mass system. Further, for those systems including a cantilever beam, it is understood that the fixation of the beam can include fixed, fixed-fixed, pinned, pinned-pinned, and combinations thereof.

In addition, the excitation of the various inventive sensors can be of any type with frequency response characteristics capable of exciting the non-linearity. Non-limiting examples include actuation by piezoelectric, electrostatic, and electromagnetic means.

Reference is made herein to the identification and excitation of a spring mass system at a saddle-node frequency bifurcation, but it is understood that the invention is not so limited and further contemplates the identification and excitation at cyclic-fold and pitchfork bifurcations. Further, it is understood that the bifurcation points may not be at the analytically or experimentally determined linear natural frequency. As shown herein the bifurcation frequencies can be found either analytically or experimentally.

A description of one embodiment in mathematical terms begins with the development of a comprehensive nonlinear, distributed-parameter model for a piezoelectrically actuated microcantilever. This model is reduced to a lumped-mass analog and subsequently analyzed using numerical continuation methods. Predicted nonlinear behaviors are experimentally validated using Veeco DMASP probes. These devices are functionalized for sensing purposes and tested in a controlled environment.

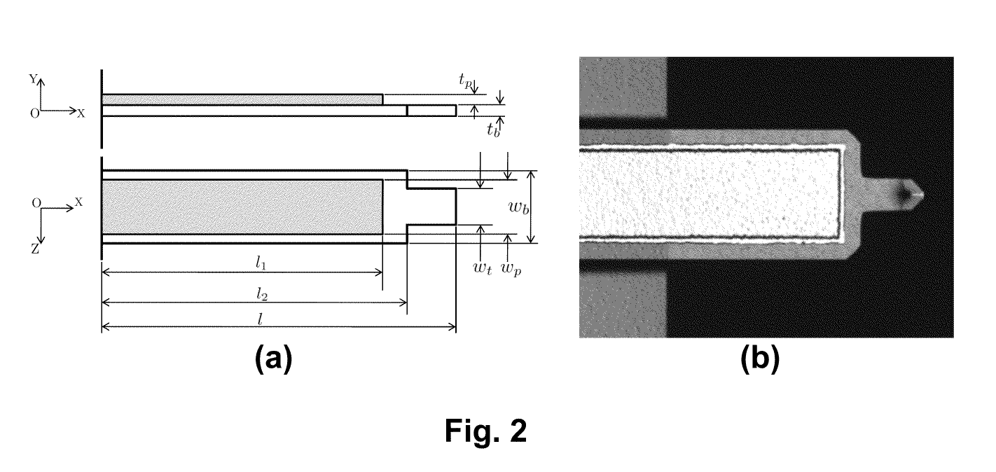

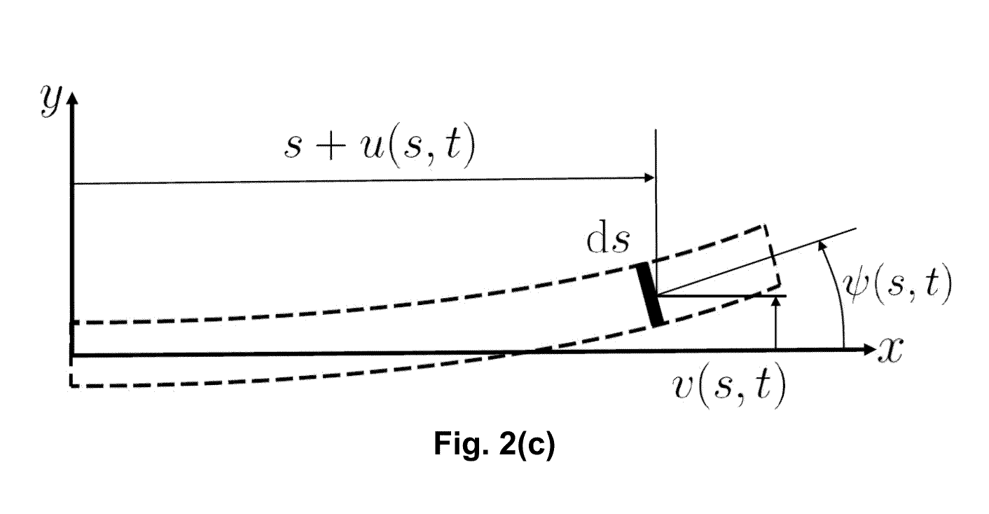

FIG. 2 highlights, schematically (FIG. 2(a)) and pictorially (FIG. 2(b)), a piezoelectrically actuated microbeam system according to one embodiment of the present invention. An applied potential across the system's piezoelectric layer serves to actuate the device. The equation of motion governing the piezoelectrically actuated microbeam can be recovered through the use of classical energy methods. This can be briefly developed as follows.

To begin, axial and transverse deformations u(s, t) and v(s, t), and the derivative operators (\dot{}) and ()′, taken with respect to time and the arc length variable s, respectively, are introduced. Assuming small (but not necessarily linear) deflections, these deformations render a kinematic constraint on the microbeam's angular deflection (Ψ) given by

$$tan Ψ = \frac{{v}^{′}}{1 + {u}^{′}} . \qquad ( 1 )$$

Likewise, the axial strain associated with the microbeam, is given by

$$\begin{matrix}{ɛ}_{11} = - ( y - {y}_{n} ) {Ψ}^{′} & for s < {l}_{1} , \\ = - y {Ψ}^{′} & for {l}_{1} < s < l ,\end{matrix} \qquad ( 2 )$$

where, yₙ is the location of neutral axis from the origin for the region s<l₁ and is defined to be

$${y}_{n} = \frac{{E}_{p} {w}_{p} {t}_{p} ( {t}_{p} + {t}_{b} )}{2 ( {E}_{p} {t}_{p} {w}_{p} + {E}_{b} {t}_{b} {w}_{b} )} . \qquad ( 3 )$$

The relationships between the induced stress and the strain in the silicon cantilever and the piezoelectric patch are derived using classical constitutive relations. For the cantilever, the constitutive equation is given by σ₁₁^{b}=E_{b}ε₁₁^{b}, while, for the piezoelectric patch, the constitutive relations are given by

$${σ}_{11}^{p} = {E}_{p} {ɛ}_{11}^{p} - {h}_{31} {Q}_{3} + \frac{{α}_{1}}{2} {( {ɛ}_{11}^{p} )}^{2} + \frac{{α}_{2}}{2} {( {Q}_{3} )}^{2} - {α}_{3} {ɛ}_{11}^{p} {Q}_{3} , \\ {D}_{3} = {h}_{31} {ɛ}_{11}^{p} + {β}_{31} {Q}_{3} + \frac{{α}_{3}}{2} {( {ɛ}_{11}^{p} )}^{2} + \frac{{α}_{4}}{2} {( {Q}_{3} )}^{2} - {α}_{2} {ɛ}_{11}^{p} Q , \qquad ( 4 )$$

where the superscripts b and p denote the beam and the piezoelectric patch, respectively, and σ₁₁, E_{b}, Eₚ, Q₃, D₃, h₃₁ and β₃₁ represent the axial stress, the elastic modulus of the beam, the elastic modulus of the piezoelectric material, the applied electric field, the electrical displacement, the effective coupling coefficient that relates the electrical and mechanical displacements, and the effective permittivity coefficient, respectively. αᵢ(i=1, 2, 3, 4) are the nonlinear material coefficients. Note that the electric field is the gradient of the applied potential with respect to the thickness variable.

Using the aforementioned relationships, the kinetic energy T and the potential energy U associated with the system can be expressed as

$$\begin{matrix}T = \frac{1}{2} {\int }_{0}^{l} m ( s ) [ {\dot{u}}^{2} + {\dot{v}}^{2} ] d s , & ( 5 ) \\ U = \frac{1}{2} {\int }_{0}^{{l}_{1}} \int {\int }_{A} {σ}_{11}^{p} {ɛ}_{11}^{p} d A d s + \frac{1}{2} {\int }_{0}^{{l}_{1}} \int {\int }_{A} {σ}_{11}^{b} {ɛ}_{11}^{b} d A d s - \frac{1}{2} {\int }_{0}^{{l}_{1}} \int {\int }_{A} {Q}_{3} {D}_{3} d A d s + \frac{1}{2} {\int }_{{l}_{1}}^{{l}_{2}} \int {\int }_{A} {σ}_{11}^{b} {ɛ}_{11}^{b} d A d s + \frac{1}{2} {\int }_{{l}_{2}}^{l} \int {\int }_{A} {σ}_{11}^{b} {ɛ}_{11}^{b} d A d s , & ( 6 )\end{matrix}$$

where m(s) and A represent the mass density and cross-sectional area of the composite system. Using these as a basis for study, the Lagrangian of the system can be assembled and used in conjunction with extended Hamilton's principle to recover the equations governing the system's transverse and longitudinal vibrations. The equation governing the system's longitudinal dynamics can be use to recover the embedded Lagrange multiplier, introduced to maintain inextensibility. Substituting this expression into the equation governing transverse vibrations yields a single, distributed-parameter equation of motion for the system. Expanding this equation, retaining terms of up to third order, and non-dimensionalizing the result, renders a final distributed parameter model. It is understood that embodiments of the present invention are not necessarily limited to or described by the mathematical analysis presented herein.

The complex distributed-parameter model referred to above can be reduced to a lumped-mass analog by decomposing the transverse displacement \hat{v} into its spatial and temporal components

\hat{v}(ŝ, \hat{t})=w(\hat{t})φ(ŝ), (7)

and projecting the result onto the first mode shape of the cantilever. This yields a lumped-mass equation of motion for the system given by

\ddot{w}+2ξωₙ\dot{w}+(ωₙ²+Δφλ₁+Δφ²γ₁)w+(k₂+Δφλ₂)w²+(k₃+Δφλ₃+Δφ²γ₃)w³+χ(w\dot{w}²+w²\dot{w})=η₁Δφ. (8)

The nondimensional coefficients in Eqn. (8) are functions of the system's geometry, resonant modeshapes, and constituent material properties. The effective linear, quadratic, and the cubic stiffnesses ω_{η}², k₂, k₃, and the nonlinear term (χ) vary strongly with system's geometry and elastic material properties and exhibit a weak dependence on material nonlinearities. Other terms in the expression are functions of the linear and nonlinear piezoelectric material coefficients.

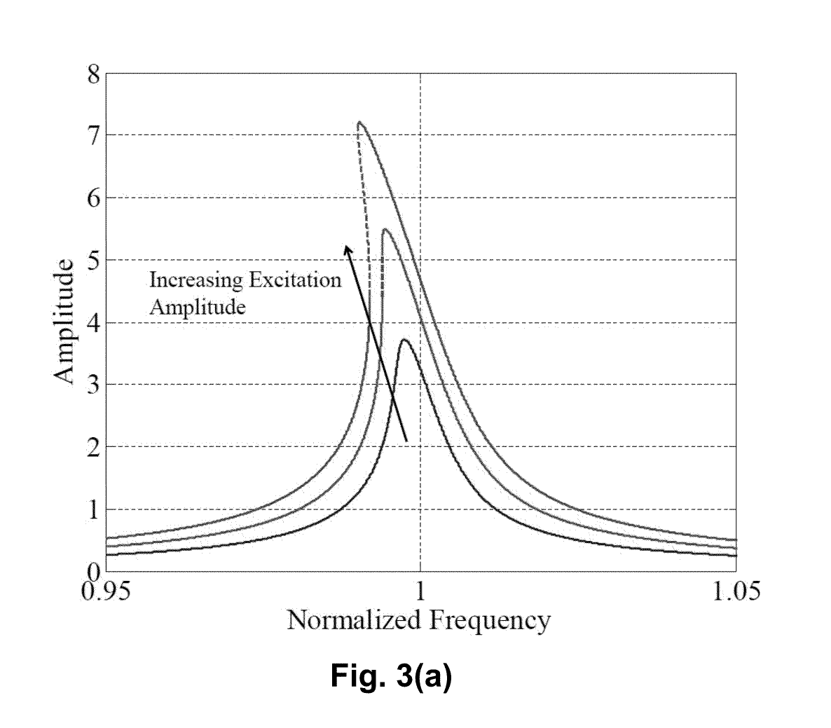

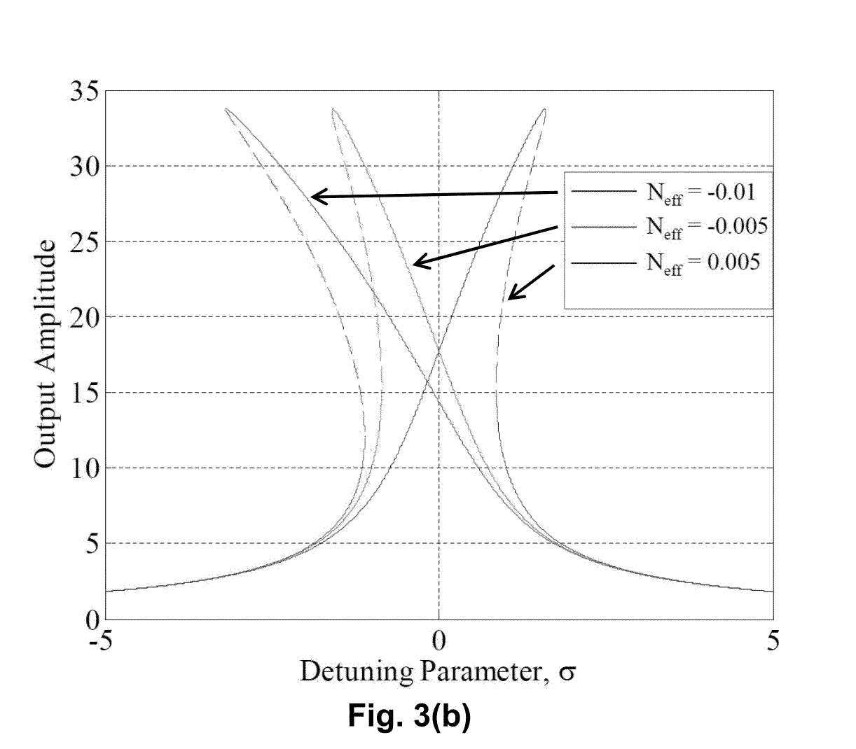

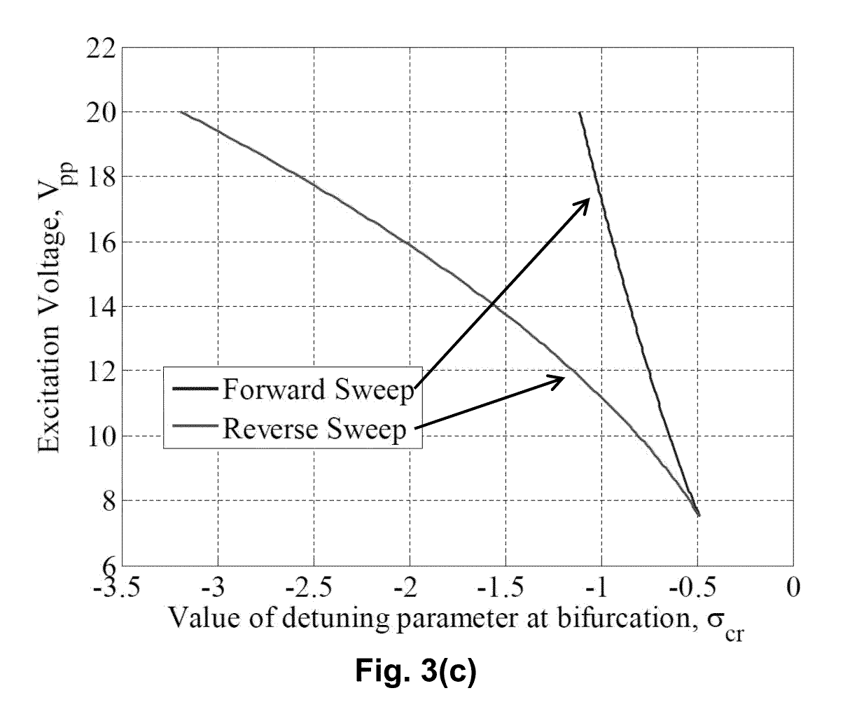

Equation (8) is highly nonlinear and fails to feature a tractable closed-form solution. Accordingly, the equation is analyzed using a numerical continuation program, AUTO. This preliminary analysis is carried out by assuming that all the nonlinear material coefficients, with the exception of α₁ , are zero. FIG. 3 depicts the frequency response structure associated with the system, under various excitation amplitudes, for a representative value of α₁ . At comparatively large excitation amplitudes, the system exhibits a softening like behavior, with coexistent stable solutions and hysteresis. Accordingly, if the system is excited at a comparatively low excitation frequency and frequency is swept to a higher value, the response amplitude will slowly increase until the excitation frequency crosses the (lower) point at which the stable and unstable solution branches meet (a saddlenode bifurcation). At this point, the response amplitude jumps to the large-amplitude response from the low amplitude state, and then decreases with increasing excitation frequency.

In contrast, if the system is excited at a comparatively high excitation frequency and frequency is swept to a lower value, the response amplitude will rapidly increase until the excitation frequency crosses the (upper) point at which the stable and unstable solution branches meet (a second saddlenode bifurcation). At this point, the response amplitude jumps to the small-amplitude response from the high amplitude state, and then decreases with decreasing excitation frequency. In such embodiments the response of the sensor depends upon the excitation path leading up to that response.

FIG. 3b shows the frequency response behavior of the system for representative values of the system parameters, an excitation amplitude of 10 V and for different values of the effective nonlinear coefficient N_{eff}. The frequency response consists of multiple solutions, both stable (represented by solid lines) and unstable (dashed lines). The frequencies at which the stable and the unstable solutions meet are the saddle-node bifurcation frequencies. This particular frequency response behavior shows two saddle-node bifurcation frequencies, with one being the frequency where the lower amplitude stable solution and the unstable solution branches meet, and the other one being the frequency where the higher amplitude stable solution and the unstable solution branches meet. For negative values of the effective nonlinear coefficient, the system shows a softening behavior while for positive values, the system shows hardening frequency response characteristics.

The effect of the amplitude of excitation on the bifurcation frequencies has been plotted in FIG. 3c. The plot shows that the hysteresis increases as the amplitude of excitation increases. To accurately estimate the bifurcation frequencies, an estimate of the effective nonlinear coefficient N_{eff} is helpful. N_{eff} is a function of the material nonlinear coefficient α₁. To estimate the material nonlinear coefficient, a simple parametric identification routine can be designed for illustrations of typical parametric identification routines. An estimate of the saddle-node bifurcation frequencies will not only lead to the choice of the operating point for the sensor, but also facilitates a study of the performance metrics of the sensor.

The sensor operates in a frequency range where multiple steady-state solutions are present. In the absence of any external perturbations and noise, the system remains on the solution branch as determined by the initial conditions, until a bifurcation point is crossed (whereat, the rate of change of amplitude as a function of frequency tends to infinity). The amplitude resolution is determined by the minimum detectable difference in amplitude between the two stable solutions at the saddle-node bifurcation frequency. For the given system, this quantity is quite high (as shown in FIG. 3b and later verified experimentally) and therefore, the sensor is not practically limited by the amplitude resolution. Thus, bifurcation-based sensors operating in the absence of noise have a minimum detectable mass of essentially zero.

in a traditional linear resonance based mass sensor, chemomechanically induced shifts in the system's resonance frequency are tracked and used to signal an analyte detection event. In contrast, a bifurcation-based resonant mass/stiffness sensor according to some embodiments of the present invention exploit the rich nonlinear frequency response structure detailed above. Such sensors may be designed to operate near a saddle-node bifurcation point designated A in FIG. 1(b). Chemomechanical interactions with a target analyte are used to alter the effective mass of the resonator. However, in this instance, the added mass serves not only to shift the system's natural frequency, but also to drive the system across the saddle-node bifurcation. This yields a rapid and dramatic jump in the system's response amplitude which can be easily detected.

To validate the feasibility and merits of the proposed nonlinear, bifurcation-based sensors a succinct experimental investigation was initiated. The nonlinear frequency response behavior of a representative device was characterized via laser vibrometry. Select microcantilevers were then selectively functionalized and tested within a carefully controlled environment using a custom test apparatus. Veeco DMASP probes, initially designed for use in scanning probe microscopy applications, were used as a test platform. These devices comprise a silicon cantilever and an integrated piezoelectric actuator incorporating a ZnO layer sandwiched between two Au/Ti electrodes.

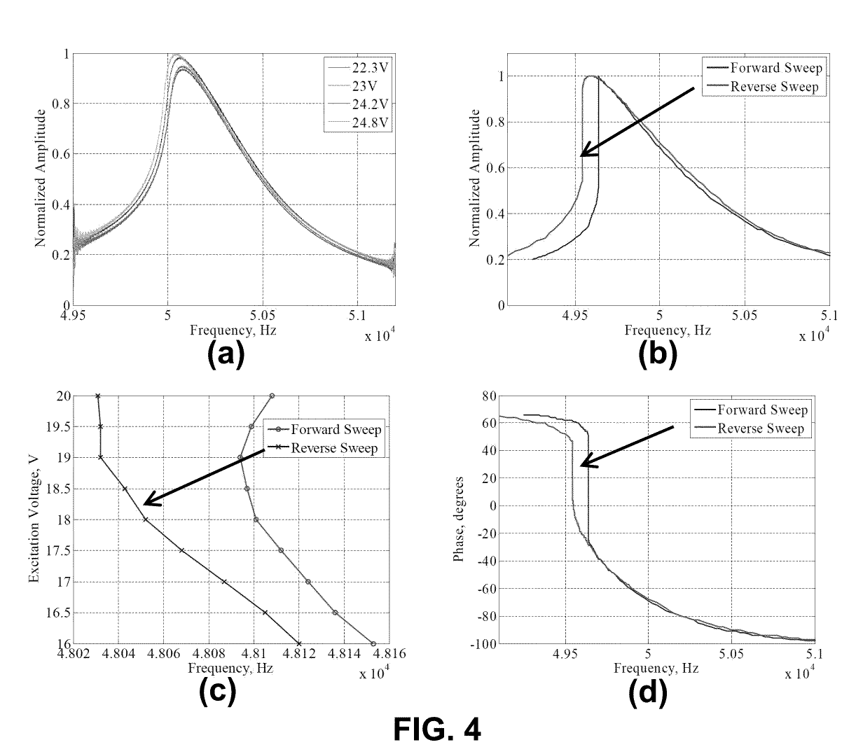

The frequency response of the Veeco DMASP probes was studied through the use of a Polytec MSA-400 Laser Doppler Vibrometer and a supplementary LabVIEW interface, which served to control the voltage input and record the steady-state frequency response characteristics of the device. Frequency sweeps were performed at a variety of sweep rates and actuation voltage levels to characterize the nonlinear response of the microcantilevers. FIGS. 4(a) and 4(b) highlight the recovered amplitude response characteristics. The results depicted in FIG. 4(a) were recovered using a sweep period of 20.48 seconds. Note that this sweep rate is sufficiently fast that the saddle-node bifurcation is captured only in passing. Although a particular sweep has been shown and described, yet other embodiments of the present invention contemplate any sweep, and further methods of sweeping in which the change in frequency can be nonlinear with time.

The system shows a mild softening behavior and the response increasingly softens with increasing excitation voltage. Similarly, FIGS. 4(b) and 4(d) highlight the amplitude and phase response of the system recovered with 20.2 Vₚₚ excitation and a 400 second sweep period. As evident, with higher sweep periods, even at a lower voltage, the system exhibits a clear saddle-node bifurcation and significant hysteresis.

Resonant mass sensors according to some embodiments can be functionalized with a polymer capable of adsorbing/absorbing solvents, vapors, and other analytes of interest. Inkjet technology has been shown to be a viable means of fabrication and sensor functionalization due to its ability to precisely deposit a small volume of liquid onto a substrate.

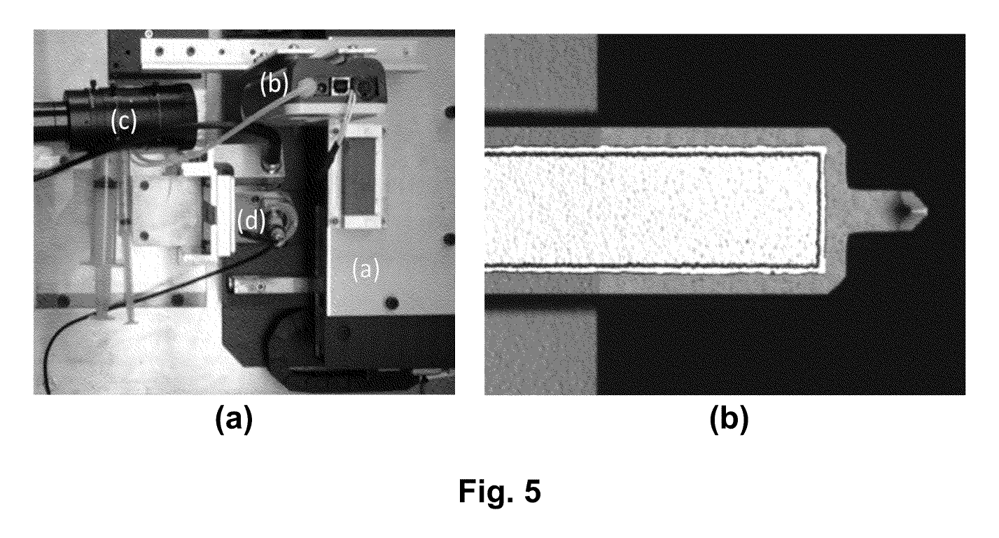

The beams were functionalized with Poly 4-Vinyl Pyridine to facilitate methanol sensing. Functionalization was carried out using a micro-inkjet printing process with thermal actuation enabled drop formation. In this functionalization process, a resistor is placed within the polymer reservoir. An electrical current is sent through the resistor causing its temperature to rise. The resistor's temperature rises until a vapor bubble forms and subsequently collapses. This induces a wave in the fluid, which, in turn, results in the formation of a drop. The inkjet system used for functionalizing the cantilevers is depicted in FIG. 5(a). It comprises of (a) a two-axis linear stage with an encoder resolution of 0.5 μm, (b) an HP TIPS thermal inkjet drop ejection system with printheads consisting of up to 18 nozzles with the ability to produce drop volumes in the range of 1-220 pL at a frequency of 45 kHz, (c) a CCD imaging system for the visualization of drop deposition, and (d) a laser registration system used for mapping fixed substrate coordinates. Each device was functionalized with 110 pL drops in less than 1 second. The functionalized beams were stored in a nitrogen environment to avoid the interactions with free radicals and to ensure the integrity of the sensor's surface chemistry prior to testing. Although a specific method of functionalization has been shown and described, yet other embodiments of the present invention contemplate any method of fabrication.

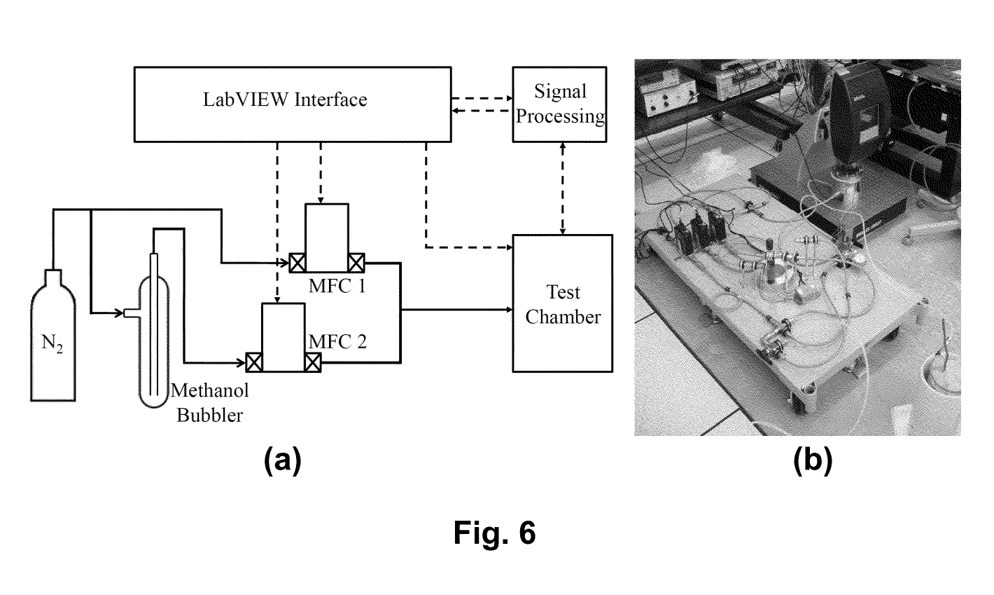

A chemical test setup for this study depicted in FIG. 6 was used to test a sensor according to one embodiment of the present invention. This test apparatus consists of multiple analyte bubblers, which are connected to precision mass flow controllers and a carrier gas (nitrogen) supply. The temperatures of the bubblers are carefully monitored and controlled through the use of RTDs and adjacent heat pads. By controlling the pressure of the carrier gas at the inlet, choosing appropriate temperature settings, and selecting appropriate flow rates for each of the mass flow controllers, any desired analyte/carrier mixture and associated concentration level can be produced. Once fully mixed, this gas is diverted into a isolated test chamber inside of which the functionalized microbeams are mounted. The test chamber is optically accessible from the top, and features a glass window which is specially coated to allow for maximum transmission of the laser signal from the vibrometer. The temperature of the test chamber is also monitored and controlled using RTDs and heat pads to avoid the condensation of analyte onto the walls of the chamber and the optical viewport. Hermetically sealed electrical outlets are located at the base of the chamber to minimize interference with chemomechanical interactions. The exhaust from the chamber is routed into a condensing chamber from which the target analyte is recovered. The entire setup, including the excitation signal to the beam and recovered signal from the vibrometer, is monitored and controlled using a LabVIEW interface.

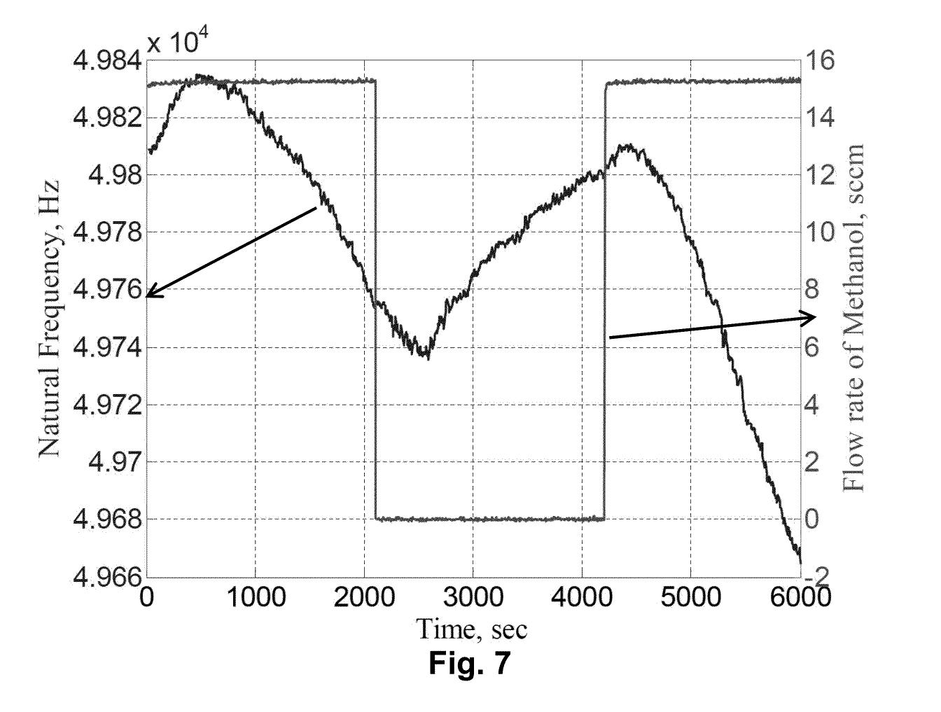

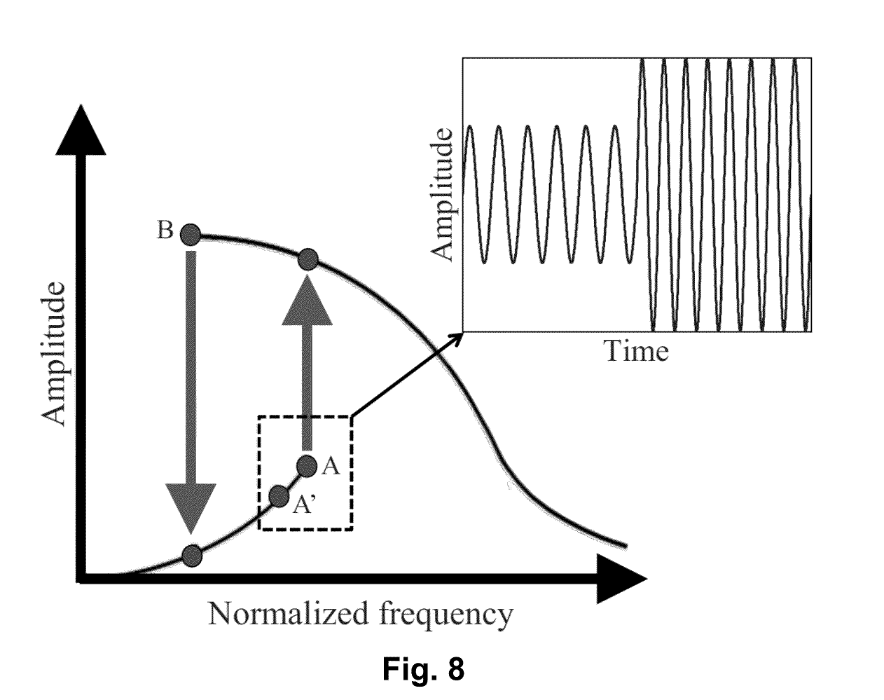

To validate the performance of the functionalized Veeco DMASP probes and the chemical test chamber itself, the microcantilevers were subjected to a series of mass sensing trials based on their linear frequency response. Specifically, the cantilevers were excited using a 2 V pseudorandom signal. Methanol was then supplied at a pre-determined concentration and rate into the chamber. To achieve successive adsorption and desorption of the gas molecules on the functionalized surface, the methanol/nitrogen mixture was supplied for a fixed period of time and then the system was purged with pure nitrogen. This alternating cycle of gas supply was controlled via LabVIEW. As evident from FIG. 7, the expected behavior was recovered, as shown with an analyte/carrier concentration of 3.5% by mass.

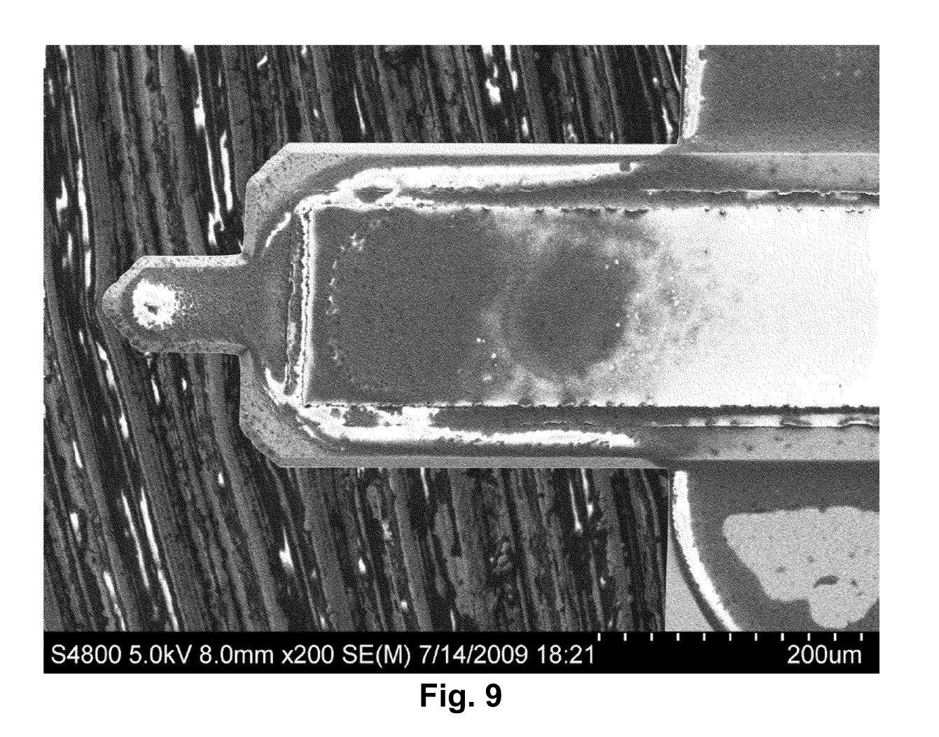

In yet another embodiment of the current invention, commercially available Veeco DMASP probes, initially designed for scanning probe microscopy applications, were selected as a test bed in this study. These devices consist of a silicon cantilever and an integrated piezoelectric layer, incorporating a ZnO layer sandwiched between two Au/Ti electrodes. To facilitate mass sensing, the cantilevers were polymerically functionalized, using inkjet printing technology. Specifically, a micro-inkjet printing process with thermal-actuation enabled drop formation was used to functionalize the beams with Poly-4 Vinyl Pyridine—a polymer used for methanol sensing. FIG. 9 shows an SEM image of a probe post-functionalization according to one embodiment of the present invention.

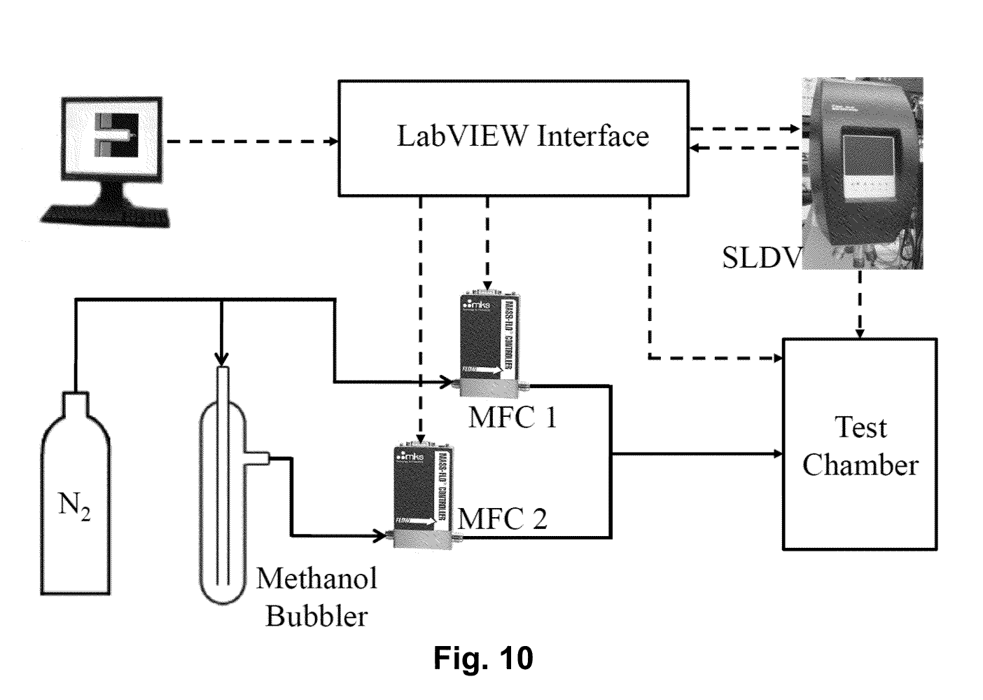

The experimental setup included of a scanning laser Doppler vibrometer (used for optical readout in this proof-of-concept study), a custom-designed, environmental test chamber, and associated test hardware (FIG. 10). Variations in the pressure of the carrier gas at the inlet of the bubbler, the temperature of the liquid in the bubbler, and the flow rates at the mass flow controllers were used to produce a wide range of analyte/carrier gas concentrations within the test chamber, inside of which the functionalized microcantilevers had been placed. The entire setup, including the excitation and recording of the frequency response characteristics of the beam, was controlled via a LabVIEW interface.

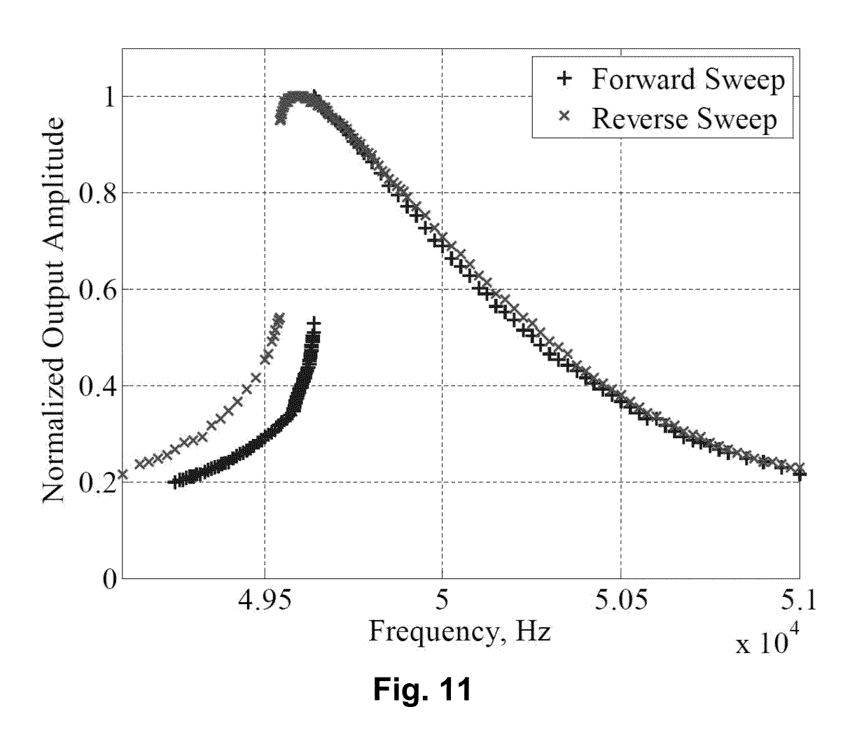

Using the laser Doppler vibrometer, the frequency response of the functionalized beams was recovered. Frequency sweeps were performed at a variety of sweep rates and actuation voltage levels to characterize the nonlinear behavior of the devices. FIG. 11 shows the response of a representative device for a sweep period of 400 seconds at 20.2 V ₚₚ. Saddle-node bifurcations are present in both the forward and reverse sweeps, along with a clear softening, hysteretic behavior.

To validate the performance of the probes and test chamber, the microcantilevers were first subjected to a series of conventional, linear mass sensing trials. Methanol/nitrogen gas mixtures were supplied for various periods of time and the system was periodically purged with nitrogen to ensure the successive adsorption and desorption of methanol molecules onto the functionalized surface. As the molecules adsorbed on the surface, the natural frequency of the devices decreased and as the molecules desorbed, the natural frequency increased, indicating a mass-dominated chemomechanical process. However, it is understood that yet other embodiments of the present invention pertain to cantilevers that include a stiffness-dominated chemomechanical process, as well as those devices that include both mass and stiffness properties altered chemomechanically.

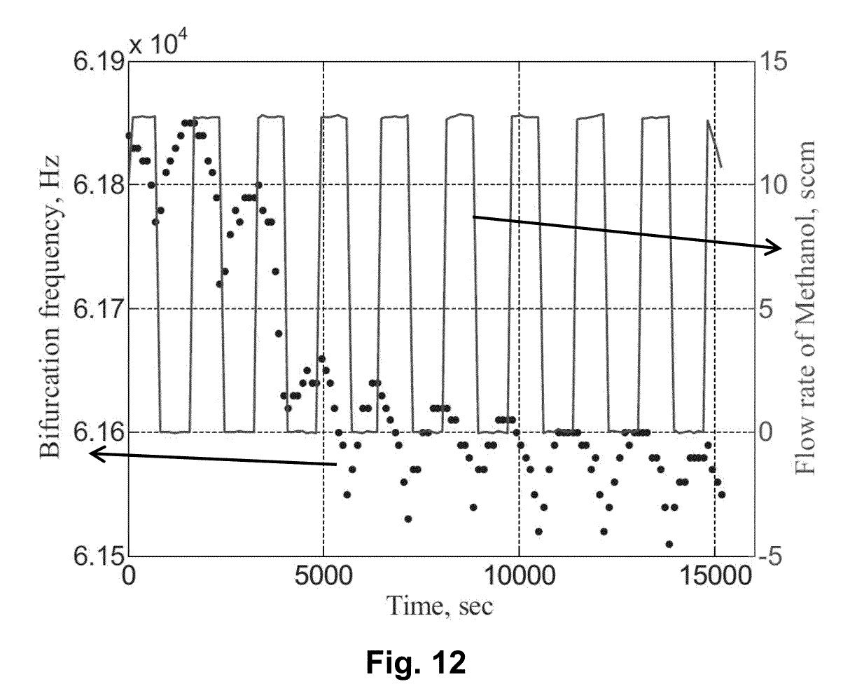

To study the change in bifurcation frequency as a function of the applied mass, the device was subjected to a sequence of adsorption and desorption cycles and the saddle-node bifurcation frequency during the forward sweep was recorded at each step. FIG. 12 shows a representative plot of the saddle-node bifurcation frequency as a function of time, plotted with the flow rate of the target analyte. This trial was performed with a concentration setting of 1.18% by mass of analyte in the carrier gas mixture (as specified at the mass flow controllers). The bifurcation frequency decreased at an approximate rate of 0.125 Hz/s as the mass was adsorbed onto the surface and increased at an approximate rate of 0.076 Hz/s as the analyte desorbed. This trend matched that previously seen with the linear natural frequency.

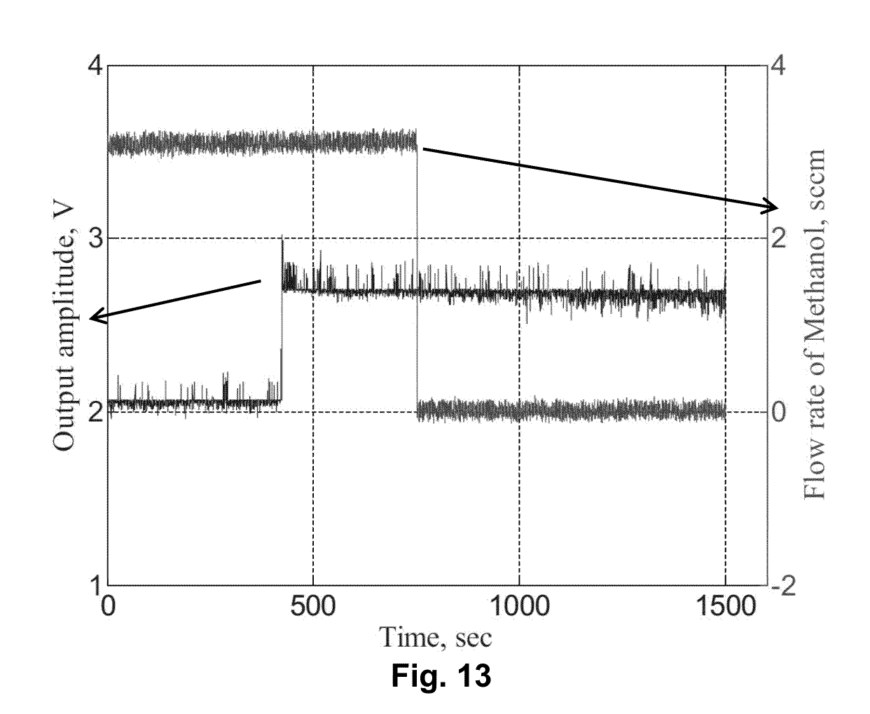

Using the results of the aforementioned procedure as a benchmark, an operating point for each device was selected based on that particular device's bifurcation frequency. The operating point was typically a few Hz below the saddle-node bifurcation frequency. The device was then driven at this constant frequency and the near-resonant amplitude of the device was recorded via the laser vibrometer. As the analyte/carrier gas mixture was injected into the test chamber, the bifurcation frequency decreased below the set frequency at which the system was operating and the response amplitude abruptly jumped from the low-amplitude state to the high-amplitude state, signaling a detection event. FIG. 13 shows a representative plot of the response amplitude versus time for a concentration of 0.67% by mass of the analyte/carrier gas concentration (as specified at the mass flow controllers). The set frequency here was specified to be 30 Hz less than the bifurcation frequency. The positive detection event report here has been repeated with different devices and at different concentration levels, with few, if any, false positives and negatives having been observed to date.

The representative experimental results highlighted in FIGS. 12 and 13 show that bifurcation-based mass sensors founded upon abrupt transitions in near-resonant amplitude that take place across saddle-node bifurcations are feasible. Furthermore, the work demonstrates that with sensor calibration and exploitation of the devices' self-sensing capability, the technique eliminates the need for complex frequency tracking hardware, as it can just use amplitude monitoring or thresholding, and thus simplifies final device implementations. Note that to properly estimate the sensitivity of bifurcation-based sensors detailed herein, an estimation of the saddle-node frequency may be used. The experimental determination of this frequency is in some circumstances pertains to the stochastic nature of the switching process, the rate of the frequency sweep, and resistive heating in the piezoelectric element. Alternatives and improvements in characterizing this sensitivity, optimizing sensor metrics, and exploiting the devices' inherent self-sensing capability in an integrated device architecture will occur to those skilled in the art.

Sensors according to some embodiments were put through a series of randomized test cycles. As a first step during each test cycle, the bifurcation frequency was identified (to minimize the uncertainties in the estimation of the operating point for the sensor). Once the operating point was identified, the sensor was excited at a constant frequency and the dynamic response was recorded. A random number generator was used to determine whether the analyte/carrier gas mixture was supplied to the sensor or the sensor was supplied with pure carrier gas. The response of the sensor was then investigated to determine the number of correct positive detection or negative detection events and the number of false positives and false negative detection events.

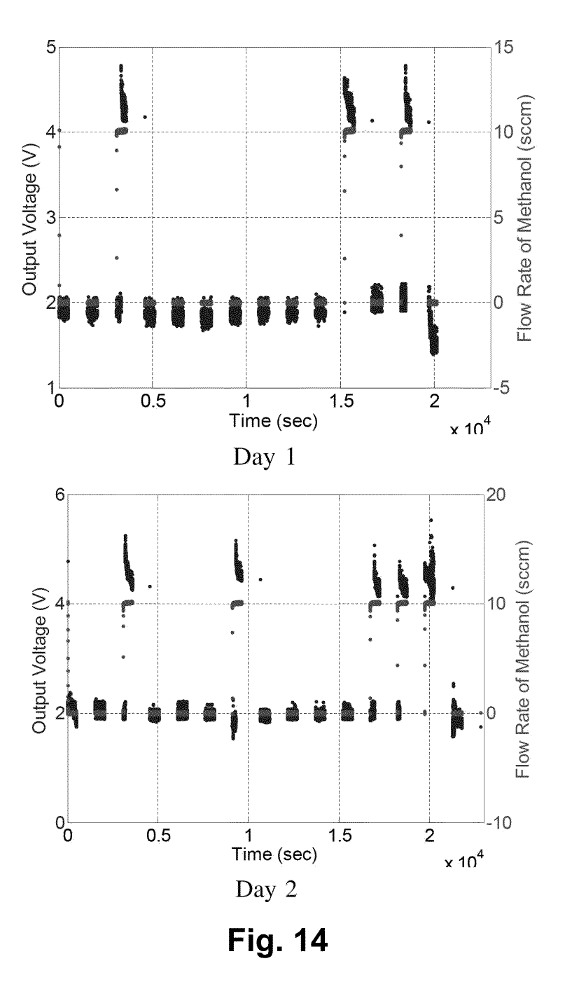

FIG. 14 shows two representative tests (carried out on two different days), performed with a concentration of 1:18% by weight of methanol in nitrogen, as specified at the mass flow controllers. Table II describes the results from FIG. 11 in terms of the detection events. As shown, the sensor achieved positive detection every time the analyte/carrier gas mixture was supplied and there were no detection events when only pure carrier gas was supplied. Anomalies arose in a few detection events when the system detected bifurcation prematurely (Trial 11 on Day 1 and Trial 14 on Day 2). This is attributed to the error in the estimate of the bifurcation frequency (which was also controlled by the LabVIEW interface), and thus traced to calibration rather than hardware failure.

All publications, prior applications, and other documents cited herein are hereby incorporated by reference in their entirety as if each had been individually incorporated by reference and fully set forth. While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

While the inventions have been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

TABLE II
RESULTS OF THE RANDOMIZED TESTING CYCLES USED TO
STUDY THE RELIABILIY OF THE SENSING PROCESS.

| | | Identified | | | |
|---|---|---|---|---|---|
| | Cycle | Bifurcation | Analyte/Carrier | | |
| | No. | Frequency (Hz) | gas mixture | Detection | Comments |
| Day 1 | 1 | 60130 | No | No | Premature |
| | 2 | 60180 | No | No | bifurcation |
| | 3 | 60200 | Yes | Yes | |
| | 4 | 60190 | No | No | |
| | 5 | 60200 | No | No | |
| | 6 | 60210 | No | No | |
| | 7 | 60230 | No | No | |
| | 8 | 60230 | No | No | |
| | 9 | 60240 | No | No | |
| | 10 | 60220 | No | No | |
| | 11 | 60280 | Yes | Yes | |
| | 12 | 60190 | No | No | |
| | 13 | 60240 | Yes | Yes | |
| | 14 | 60180 | No | No | |
| Day 2 | 1 | 60170 | No | No | Premature |
| | 2 | 60200 | No | No | bifurcation |
| | 3 | 60230 | Yes | Yes | |
| | 4 | 60150 | No | No | |
| | 5 | 60180 | No | No | |
| | 6 | 60200 | No | No | |
| | 7 | 60180 | Yes | Yes | |
| | 8 | 60190 | No | No | |
| | 9 | 60210 | No | No | |
| | 10 | 60210 | No | No | |
| | 11 | 60230 | No | No | |
| | 12 | 60220 | Yes | Yes | |
| | 13 | 60190 | Yes | Yes | |
| | 14 | 60150 | Yes | Yes | |
| | 15 | 60200 | No | No | |

What is claimed is:

1. A method for detecting a compound, comprising:
providing a cantilever beam, the beam including a material structurally integrated with the beam that responds to the presence of the compound nonlinearly in the dynamic response of the cantilever beam;
electrically exciting the cantilever beam to vibrate;
measuring the dynamic response of the excited beam;
exposing the beam and the material to the compound after said measuring;
electrically reexciting the cantilever beam after said exposing;
remeasuring the dynamic response of the reexcited beam; and
comparing the measured response to the remeasured response.

2. The method of claim 1 wherein the material adsorbs the compound and the nonlinearity corresponds to the weight of the compound.

3. The method of claim 1 wherein the material absorbs the compound and the nonlinearity corresponds to the weight of the compound.

4. The method of claim 1 wherein the nonlinearity corresponds to a change in the stiffness of the cantilever beam.

5. The method of claim 1 wherein the beam includes a piezoelectric actuator and said electrically exciting is of the actuator.

6. The method of claim 1 wherein the cantilever beam includes a non-electrically conductive structure and the material is a polymer compound placed on the structure.

7. The method of claim 1 wherein the dynamic response is at about the natural frequency of the cantilever beam.

8. The method of claim 1 wherein the dynamic response is the amplitude of the vibrating cantilever beam.

9. The method of claim 1 wherein said exciting is a frequency sweep.

10. The method of claim 1 wherein said reexciting is a frequency sweep.

11. The method of claim 1 wherein said exciting is a frequency sweep in a direction, and said reexciting is a frequency sweep in the opposite direction.

12. The method of claim 1 wherein said exciting is a dwell at a predetermined frequency.

13. The method of claim 1 wherein said reexciting is a dwell at a predetermined frequency.

14. The method of claim 1 wherein said exciting is a dwell at a predetermined frequency, and said reexciting is a dwell at substantially the same frequency.

15. The method of claim 1 wherein said reexciting is an uninterrupted continuation of said exciting.

16. The method of claim 1 wherein the beam has a length and the length is less than about one millimeter.

17. The method of claim 1 wherein the nonlinearity is one of a softening linearity such that the resonant frequency decreases as driving signal increases, or a hardening linearity such that the resonant frequency increases as driving signal increases.

19. The method of claim 1 wherein the cantilever beam has one fixed end and one free end.

20. The method of claim 1 wherein the cantilever beam has two fixed ends.

21. The method of claim 1 wherein the cantilever beam has a pinned end and a free end.

22. The method of claim 1 wherein the cantilever beam has two pinned ends.

23. The method of claim 1 wherein the cantilever beam has a fixed end and a pinned end.

24. The method of claim 1 wherein the beam includes one of an electrostatic actuator and said electrically exciting is of the actuator, or an electromagnetic actuator and said electrically exciting is of the actuator, or an electroresistive actuator and said electrically exciting is of the actuator.

25. A method for detecting a compound, comprising:
providing a spring-mass system including a material having a characteristic responsive to the presence of the compound;
determining a frequency at which the system and material exhibit a nonlinear bifurcation response;
exposing the system and material to the compound;
driving the system and material at the frequency; and
detecting a change in the amplitude response of the system and material corresponding to a change in the amount of the compound.

26. The method of claim 25 wherein the bifurcation response is one of the pitchfork type, the cyclic type, or the saddle type.

27. The method of claim 25 wherein said determining is by mathematical analysis.

28. The method of claim 25 wherein said determining is by experimentation.

29. The method of claim 25 wherein the response is to increase weight.

30. The method of claim 25 wherein the response is to change stiffness.
